(19) United States
(12) Patent Application Publication
(10) Pub. No.: US 2005/0210675 A1
(43) Pub. Date: Sep. 29, 2005

(54) Sealed tubeless tire bicycle wheel

(76) Inventors: Chad Nathaniel Price, Madison, WI (US); Keith Bontrager, Santa Cruz, CA (US)

Correspondence Address: DAVID C. BREZINA;BARNES & THORNBURG, P.O. BOX 2786, CHICAGO, IL, 60690, US

(21) Appl. No.: 10/810,077

(22) Filed: Mar. 26, 2004

(51) Int. Cl. B60C 15/036; B60C 5/16; B60C 15/02; B60C 29/06; B60C 29/02; B60C 19/04; B60B 21/12

(52) U.S. Cl. 29/894.31; 152/514; 152/427; 152/381.6; 152/384; 29/894.351

(57) ABSTRACT

Pneumatic tires adapted to use on bicycles have a number of criteria that need to be evaluated. For high performance bicycle riding, such as in mountain bike races, it is advantageous to optimize performance. Standard tires with tubes have ease of repair in the replacement of a punctured tube, have the ability to maintain pressure for long periods, and do not require special adaptation of the rim for sealing.

### BACKGROUND OF THE INVENTION

1. Field of the Invention

A bicycle wheel adapted to use with both tubeless and standard, tubed bicycle tires has a tire well with outwardly extending hook bead flanges to receive a pair of tire beads. A full width rim strip extends from an edge upstanding against one of the flanges, across the entire tire well, including a recessed channel, to the opposite flange, also terminating in an edge upstanding against the opposite flange. Raised circumferential ridges are formed on the rim strip to aid in sealing a tubeless tire. A removable valve enables the use of a tire with a standard ply and tread arrangement but with tubeless beads for improved performance. The use of a viscous sealing material enables use of the tire without a tube, having lighter weight and enabling lower pressure air pressures.

2. Description of Related Art

Pneumatic tires adapted to use on bicycles have a number of criteria that need to be evaluated. For high performance bicycle riding, such as in mountain bike races, it is advantageous to optimize performance. Standard tires with tubes have ease of repair in the replacement of a punctured tube, have the ability to maintain pressure for long periods, and do not require special adaptation of the rim for sealing.

Wheels with tubeless bicycle tires were hoped to have been lighter, because of the absence of the tube, but the tubeless arrangement requiring a sealed rim, a bead to rim seal and an air impermeable tire has proven to be heavier than a tubed wheel. In the prior art, efforts have been made to perfect the bead to rim seal, and to seal spoke holes in the rim. Typically, air impermeability has been accomplished by including a sealing layer in the manufacture of the tire itself. Additionally a variety of valve arrangements have also been adapted.

Valves and the sealing of valves for tubeless tires are shown in U.S. Pat. No. 6,119,746, European Patent No. EP0616911A2 and U.S. Pat. No. 6,588,474.

U.S. Pat. No. 6,568,446 shows tubeless bicycle tire construction. Other tire constructions are illustrated in U.S. Pat. Nos. 4,243,450, 4,852,625 and 6,457,501, although this latter is for an automobile or truck.

Rim strips in tubeless tires are shown in Stringer, U.S. Pat. No. 6,019,149. A full width, but flat, rim strip is shown in German Patent publication No. DE 19542982 A1.

Thomasberg, U.S. Pat. No. 6,237,662 shows a particular tubeless tire bead that seals against a rim. Ball, U.S. Pat. No. 6,457,501 does so as well, although the rim appears to be a particularly wide rim perhaps unsuitable for a bicycle.

A variety of different tubeless bicycle wheel rim approaches are known. These include several LaCombe patents, U.S. Pat. No. 6,257,676, 6,443,533 and 6,641,227, which show ridges in the extruded metal rim itself. Ridges for holding tire beads are also shown in European application EP0103724A1 to Kunze and in U.S. Pat. No. 4,151,870. A recessed center channel, or ‘drop center’ tubeless tire rim, in which the ‘drop center’ is used to assist in urging the tire beads to seat on the rim, is disclosed in US Patent No.

Other tubeless bicycle rims are arranged so that the tire well is not penetrated by the spokes. These include U.S. Pat. Nos. 2,937,905, 3,008,770, 6,536,849, 6,474,746 and 6,582,029,.

### SUMMARY OF THE INVENTION

A tubeless, tired, spoked bicycle wheel uses a hollow rim with outwardly extending hook bead flanges to capture the bead of a lightweight tire. The tire well of the rim has a central channel. Spaced outwardly from this central channel and intersecting the flanges and breakwalls are flat circumferential webs. The channel and spoke bed are drilled for insertion of spoke nipples to retain spokes for the lacing of the rim into a complete wheel. The complete tire well is sealed with a rim strip. The rim strip has tapered edge flanges, intermediate webs and a channel portion with angled walls and a floor corresponding to the shape of the rim channel. Upstanding on the intermediate portion are circumferential ridges which closely correspond to the interior corner of the tire bead.

The tire has tubeless sealing beads with a casing extending thereacross in a U shape with an exterior coating and tread integrally formed therewith. The casing, coating and tread combination is formed without an integral interior sealing coating.

The special tire is shipped for transportation and display with a standard tube and a separate valve. In the shipping and display mode, the wheel is considered “tubeless-ready”. For shipment and display, a tube is necessary because, although capable of operation in high performance bicycling, for long term storage and shipment, some air loss will occur, thus a tube is necessary for this long term storage and shipment.

The wheel is prepared for tubeless use by removal of one bead from engagement with a selected hook bead flange, removal of the tube, insertion and fastening of the sealed valve in a valve hole in the rim, replacement of the bead on the hook bead flange, insertion of a viscous tire sealing compound through the valve and then inflating the tire pneumatically.

Inflation with the viscous sealing compound in place will displace the beads from the channel to engagement with the hook bead on the top and outside and mutual distortion of the bead and ridge to the point where the lower edge of the bead passes substantially over the ridge, the ridge and bead therefore mutually coacting to seal against substantial air loss.

Prior art tubeless tires are formed with the typical end casing and additionally, with a permanently bonded or integrally formed sealing layer or alternatively formed of low air permeable materials. This structure typically has greater mass than a standard tubed tire where the inner tube provides the air impermeable layer.

A practice among bicycle riders, particularly competitive bicycle riders for whom weight is a greater consideration and who wish to have lower, but consistent, tire pressures or improved handling characteristics, is to use a standard tire with a viscous sealing solution. This has the disadvantages of not having an adequate seal between the bead configuration and the rim. Thus, in the prior art, the choices are either a heavier, tubeless tire or a lighter, standard tire subject to greater air loss.

The invention combines attributes of both with an appropriate rim and rim strip structure.

### BRIEF DESCRIPTION OF THE DRAWINGS

FIG. 1 is a cross sectional view of a rim and tire.

FIG. 2 is a longitudinal sectional view of a rim.

FIG. 3 is a prior art rim and tire.

FIG. 4 is a perspective view of a rim.

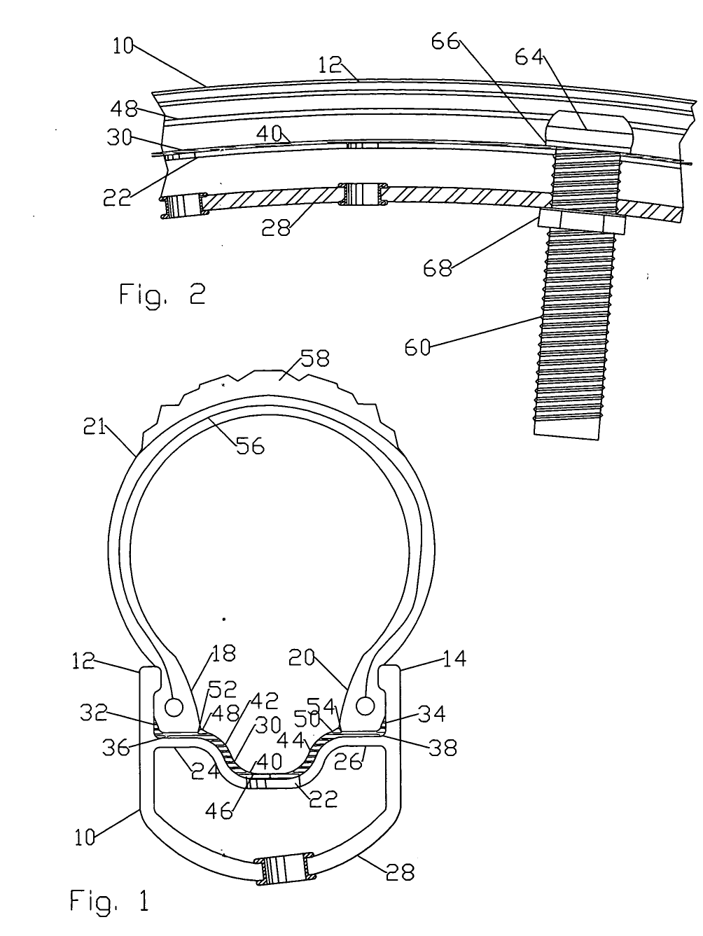

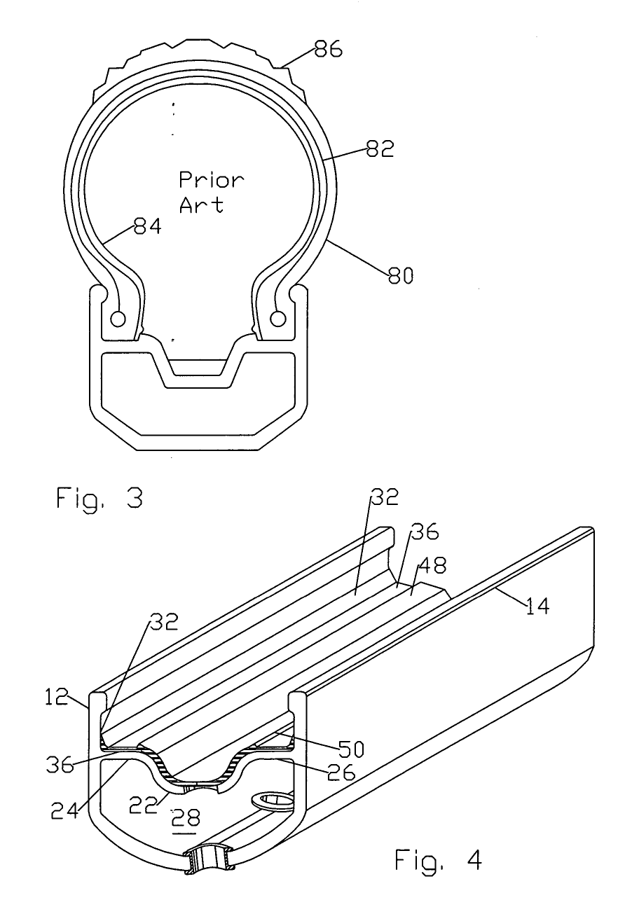

### DETAILED DESCRIPTION

A tubeless, tired, spoked bicycle wheel uses a hollow rim 10 with outwardly extending hook bead flanges 12, 14 extending outward from a tire well 16 to capture the beads 18, 20 of a lightweight tire 21. The tire well 16 of the rim 10 has a central channel 22. Spaced outwardly from this central channel and intersecting the flanges and brakewalls are circumferential webs 24, 26. The channel 22 and spoke bed 28 are drilled for insertion of spoke nipples to retain spokes for the lacing of the rim into a complete wheel. The complete tire well 16 is sealed with a rim strip 30. The rim strip 30 has tapered edge flanges 32, 34, intermediate portions 36, 38 and a channel portion 40 with angled walls 42, 44 and a floor 46 corresponding to the shape of the rim channel 22. Upstanding on the intermediate portions 36, 38 are circumferential ridges 48, 50 which closely correspond to the interior corners 52, 54 of the tire beads 18, 20.

The tire 21 has tubeless sealing beads 18, 20 with a casing or body 56 extending thereacross in a U shape with an exterior tread 58 formed on the exterior of the casing or body 56. The casing and tread combination is formed without an integral interior sealing coating, using typical tire construction techniques of forming plies, use of adhesive, curing and the like.

The special tire 21 is shipped for transportation and display with a standard tube and a separate valve 60. In the shipping and display mode, the wheel is considered “tubeless-ready”. For shipment and display, a tube is necessary because, although capable of operation in high performance bicycling, for long term storage and shipment, some air loss will occur, thus a tube is necessary for this long term storage and shipment.

Valve 60 has a threaded barrel 62 with an enlarged interior end 64 and a seal 66 that will form a substantially airtight seal against floor 46 when nut 68 is tightened. The valve 60 may be configured as a customary Schraeder or Presta type. A removable valve core eases application of the sealant directly through the valve

The wheel is prepared for tubeless use by removal of one bead 18, or 20, from engagement with a selected hook bead flange, 12 or 14, removal of the tube, insertion and fastening of the sealed valve 60 in a valve hole in the rim 10, replacement of the bead 18 or 20 on the hook bead flange 12 or 14, insertion of a viscous tire sealing compound through the valve 60 and then inflating the tire pneumatically.

Inflation with the viscous sealing compound in place will displace the tire beads 18 and 20 to engagement with the hook beads 12 and 14. Mutual distortion of the tire beads 18, 20 and ridges 48, 50 to the point where the lower edge of the tire beads 18, 20 passes substantially over the ridge 48, 50. When inflated, the tire beads 18, 20 are therefore in contact with hook beads 12, 14, ridges 48, 50, tapered edge flanges 32, 34, and intermediate portions 36, 38 all mutually coacting to seal against substantial air loss.

Prior art tubeless tires 80 are formed with the typical casing or body 82, formed of adhesively bonded plies and additionally, with a permanently bonded or integrally formed sealing layer 84 and tread 86. This structure typically has greater mass than a standard tubed tire itself where the inner tube provides the air impermeable layer. In practice, layer 84 is typically a butyl rubber layer. The Figure illustrates the tire schematically. It will be understood that the formation of the tire is more complex than illustrated herein. An example is shown in U.S. Pat. No. 6,568,446. Other tire constructions are illustrated in U.S. Pat. Nos. 4,852,625, 6,457,501 (although for an automobile or truck)

A practice among bicycle riders, particularly competitive bicycle riders for whom weight is a greater consideration and who wish to have lower, but consistent, tire pressures or improved handling characteristics, is to use a standard tire with a viscous sealing solution. This has the disadvantages of not having an adequate seal between the bead configuration and the rim. Thus, in the prior art, the choices are either a heavier, tubeless tire or a lighter, standard tire subject to greater air loss.

The invention combines attributes of both with an appropriate rim and rim strip structure. The rim strip can be advantageously formed from a thermoplastic elastomer (TPE) such as that sold under the trade name Santoprene, by the company of the same name.

1. A bicycle wheel comprising:
a rim with a tire well, spoke bed and brake walls;
a tire received in said rim;
said tire well having outwardly extending hook bead flanges to receive a pair of tire beads;
said tire well includes a recessed center channel;
a full width rim strip extends from an edge upstanding against one of the flanges, across the entire tire well, including said recessed channel, to the opposite flange, said rim strip terminating in an edge upstanding against the opposite flange;
said rim strip having integral raised circumferential ridges to aid in sealing a tubeless tire;
a removable valve having a barrel, an enlarged end and a fastener for fixing and sealing said valve in said tire well and against said rim strip;
wherein said wheel is adapted to use with both tubeless and standard, tubed bicycle tires;
said wheel has a tubeless tire;
said tire is formed with a casing and a tread;
said tire has beads adapted to be mechanically and sealingly retained against said hook beads and rim strip;
said tire is formed without a separate sealing layer;
said tire is sealed and rendered substantially air impermeable by the introduction of a viscous sealing compound prior to inflation;
said rim strip is formed of a plastic material being air impermeable and resilient so as to promote a mechanical seal with said valve and with said tire beads;
said wheel formed as a tubeless ready kit comprising a rim, tubeless bead tire, insertable and removable valve and a removable inner tube.

2. A bicycle wheel comprising:
a rim with a tire well, spoke bed and brake walls;
a tire received in said rim;
said tire well having outwardly extending hook bead flanges to receive a pair of tire beads;
said tire well includes a recessed center channel;
a full width rim strip extends from an edge upstanding against one of the flanges, across the entire tire well, including said recessed channel, to the opposite flange, said rim strip terminating in an edge upstanding against the opposite flange;
said rim strip having integral raised circumferential ridges to aid in sealing a tubeless tire;
a removable valve having a barrel, an enlarged end and a fastener for fixing and sealing said valve in said tire well and against said rim strip;
wherein said wheel is adapted to use with both tubeless and standard, tubed bicycle tires.

3. The wheel of claim 2 further comprising:
said wheel has a tubeless tire;
said tire is formed with a casing and a tread;
said tire has beads adapted to be mechanically and sealingly retained against said hook beads and rim strip;
said tire is formed without a separate sealing layer.

4. The wheel of claim 2 further comprising:
said tire is sealed and rendered substantially air impermeable by the introduction of a viscous sealing compound prior to inflation.

5. The wheel of claim 2 further comprising:
said rim strip is formed of a plastic material being air impermeable and resilient so as to promote a mechanical seal with said valve and with said tire beads.

6. The wheel of claim 2 further comprising:
said wheel formed as a tubeless ready kit comprising a rim, tubeless bead tire, insertable and removable valve and a removable inner tube.

7. A method of shipping, storing and servicing bicycle wheels comprising:
(a) forming a bicycle wheel kit of a rim with a tire well with a recessed center channel, a spoke bed and brake walls, a tire received in said rim, tire bead receiving flanges, a full width rim strip extends from an edge upstanding against one of the flanges, across the entire tire well, including said recessed channel, to the opposite flange, said rim strip terminating in an edge upstanding against the opposite flange and said rim strip having integral raised circumferential ridges to aid in sealing a tubeless tire and a removable valve having a barrel, an enlarged end and a fastener for fixing and sealing said valve in said tire well and against said rim strip, said removable valve being shipped with said wheel in an uninserted state;
(b) mounting an inner tube and a tubeless tire on said wheel, in which said tubeless tire is formed with a casing, a tread, and beads adapted to be mechanically and sealingly retained against said hook beads and rim strip, said tire being formed without a separate sealing layer;
(c) (d) inflating said inner tube;
(e) shipping and storing said wheel maintaining a state of inflation;
(f) deflating and removing said inner tube;
(g) inserting and sealing said valve;
(i) introducing a viscous sealing compound into said rim and tire combination prior to inflation so that said tire is sealed and rendered substantially air impermeable.
